(19) United States
(12) Patent Application Publication
(10) Pub. No.: US 2026/0189657 A1
(43) Pub. Date: Jul. 2, 2026

(54) OUTBOUND CALL CENTER DIALING MANAGER

(71) Applicant: Perry Johnson Mortgage Company, Inc., Troy, MI (US)

(72) Inventors: Perry L. Johnson, Troy, MI (US); Michael J. Fetting, Troy, MI (US)

(21) Appl. No.: 19/005,404

(22) Filed: Dec. 30, 2024

(51) Int. Cl. H04M 3/523; H04M 3/22; H04M 3/51

(52) U.S. Cl. CPC H04M 3/5232; H04M 3/229; H04M 3/5175; H04M 3/5183

(57) ABSTRACT

A call management system for an outbound call center uses one or more processors to select a phone number from a pool of available numbers for calls placed on one or multiple carriers. The system evaluates both carrier-specific metrics, such as the number of instances a phone number has been tagged for enhanced evaluation, the duration of these tags, and their frequency, as well as non-carrier metrics like the area code associated with the call, the number's usage history over specific time periods, and its regulatory feedback profile. Metrics for the carrier facilitating the call are weighted more heavily to optimize call performance. After selecting the most suitable phone number based on these factors, the system embeds it into the header of the call initiation message.

### TECHNICAL FIELD

This disclosure relates to telecommunications technology.

### BACKGROUND

Modern outbound call centers use a network of technologies to manage high-volume, targeted customer interactions. Unlike inbound call centers, which focus on responding to incoming inquiries, outbound centers are built for proactive communication. They reach out to customers, prospects, and other stakeholders using a range of tools, including telecommunication systems, data analytics, artificial intelligence, and compliance frameworks.

### SUMMARY

A call management system of an outbound call center comprises one or more processors programmed to select a phone number from a pool of available numbers for a call to be placed on a first carrier. The selection process considers various factors, including the number of instances each phone number has been tagged for enhanced evaluation by other carriers, the duration of such tags, and the frequency of these occurrences. Additional criteria may include the area code associated with the call, the number of times a phone number has been used for calls during specified time periods, and performance metrics specific to the first carrier. The system may also evaluate regulatory feedback profiles for each number to align with compliance requirements. Once the most suitable phone number is selected based on one or more these parameters, the system embeds the number into the header of the message used to initiate the call.

A call management system of an outbound call center includes one or more processors programmed to select a phone number from a pool of available numbers for a call to be placed on one of multiple carriers. This selection process is guided by carrier metrics associated with each phone number, where the metrics of the carrier facilitating the call are given greater weight than those of other carriers. The carrier metrics may include the number of instances a phone number has been tagged for enhanced evaluation, the duration of these tags, and the frequency with which such tags occur. In addition to carrier metrics, the system may consider non-carrier metrics, such as the area code associated with the call, the number of times each phone number has been used for calls over specified time periods, and the regulatory feedback profile of each number. Once the most appropriate phone number is selected based on these combined criteria, the system embeds the number into the header of the message that initiates the call.

### BRIEF DESCRIPTION OF THE DRAWINGS

FIG. 1 is a flow chart of a Caller ID selection algorithm.

FIG. 2 is a block diagram of a an outbound call center.

### DETAILED DESCRIPTION

Detailed embodiments are disclosed herein. These embodiments, however, are merely examples and may take various alternative forms. The figures provided are not necessarily to scale, with certain features exaggerated or minimized to emphasize details of specific components. Accordingly, the structural and functional details presented should not be viewed as limiting but rather as illustrative examples intended to guide those skilled in the art in applying the described concepts in different ways.

Telephony systems form a component of outbound call centers, facilitating voice communication with customers. Voice over Internet Protocol (VoIP) technology has become a dominant choice for these systems due to its cost-effectiveness and scalability, although traditional Public Switched Telephone Networks (PSTN) are still used in certain scenarios. PSTN remains relevant where legacy infrastructure is in place or where high reliability is prioritized in low-connectivity environments. VoIP uses protocols such as the Session Initiation Protocol (SIP) for signaling and call setup, and the Real-Time Transport Protocol (RTP) for transmitting voice data. SIP supports the initiation, modification, and termination of communication sessions, while RTP ensures the real-time delivery of audio packets. Additional protocols, like SIP-TLS, encrypt SIP messages to maintain secure signaling. VoIP systems often use codecs such as Opus and G.729 to compress audio data efficiently, striking a balance between bandwidth conservation and audio quality. Conversely, PSTN transmits uncompressed audio, which may offer consistent reliability but lacks the scalability of VoIP. To maintain consistent performance, VoIP systems implement Quality of Service (QoS) mechanisms that prioritize voice traffic and minimize latency, jitter, and packet loss. These systems are assisted by Session Border Controllers (SBCs) that enhance security and promote interoperability between carriers. Many call centers also rely on Private Branch Exchange (PBX) systems, either hosted on-premises or in the cloud, to handle internal communications and call routing. Hybrid telephony solutions that combine VoIP and PSTN are increasingly common.

Auto-dialing systems are common in outbound call centers, automating the process of initiating calls. Predictive dialers are particularly notable, using statistical algorithms such as regression analysis and real-time machine learning models to predict agent availability. These systems dynamically adjust dialing rates based on factors like agent behavior, call duration, and connection probabilities to minimize idle time and optimize resource use. Progressive dialers initiate calls only when agents are ready, reducing the risk of overloading resources, while power dialers maintain a fixed dialing rate per agent, ideal for campaigns with stringent compliance requirements. These systems integrate with SIP trunks to connect telephony infrastructure with carriers and incorporate retry logic to handle failed call attempts. Advanced configurations include call pacing algorithms that modify dialing rates in real-time based on call outcomes and compliance rules.

Customer Relationship Management (CRM) systems act as centralized repositories for customer data in outbound call centers. CRMs interface with dialing platforms through APIs, such as RESTful or GraphQL, providing real-time access to contact lists, call histories, and customer segmentation data. When a call is initiated, the CRM retrieves the relevant customer profile and displays it to the agent through middleware. These systems often leverage distributed database architectures, such as NoSQL or relational databases, capable of managing millions of records without performance degradation. Machine learning enhancements to CRMs suggest personalized communication strategies, offering recommendations tailored to each customer's preferences and history. Advanced CRM systems also include analytics dashboards that visualize engagement metrics, enabling agents and supervisors to adjust strategies dynamically and optimize customer interactions.

Analytics platforms may amplify the capabilities of outbound call centers by processing large amounts of data to refine campaigns. Machine learning models, including gradient boosting machines and neural networks, analyze historical engagement trends, demographic information, and campaign goals to predict the likelihood of customer responses. These predictions guide lead prioritization, directing resources toward high-value opportunities. Real-time processing frameworks like Apache Kafka and Apache Spark enable continuous updates to contact lists based on call outcomes. Beyond predictive analytics, some systems incorporate prescriptive analytics, offering actionable insights into optimizing campaign parameters, including call timing, script adjustments, and lead assignment strategies.

Speech analytics and artificial intelligence may enhance the effectiveness of outbound call centers. Speech analytics platforms transcribe calls in real time using Automatic Speech Recognition (ASR) systems powered by neural networks like Wav2Vec and DeepSpeech. These transcriptions feed into Natural Language Processing (NLP) engines, which analyze conversation content and sentiment. AI-driven tools generate dynamic, context-sensitive scripts to help agents navigate complex interactions more effectively. Sentiment analysis identifies emotional cues, allowing agents to adjust their approach in real-time for improved engagement. These platforms also aggregate conversation data to reveal trends such as common objections or successful techniques, offering strategic insights for refining future campaigns. Some advanced solutions integrate voice biometrics for customer authentication.

Compliance monitoring and call recording are part of the operation of outbound call centers, especially in certain regulated industries such as healthcare and finance. Call recording systems capture audio streams through SIP packet duplication or proprietary APIs and store them in encrypted formats like AES (Advanced Encryption Standard) to safeguard sensitive data. Compliance tools analyze these recordings using rule-based systems and machine learning models to identify potential deviations from regulatory standards. Real-time compliance monitoring alerts supervisors to anomalies during calls, enabling immediate corrective action. Audit trails generated by these systems provide documentation for internal reviews and regulatory inspections.

Omnichannel communication platforms may further expand the reach of outbound call centers, enabling engagement across multiple channels, including voice, email, SMS, and social media. These platforms synchronize interactions through cloud-based APIs and event-driven architectures, allowing agents to transition seamlessly between channels without losing context. AI-driven personalization tailors messages across channels to align with customer preferences and interaction history, creating a cohesive and engaging experience. Message queues like RabbitMQ manage the flow of communication data.

Cloud-based Contact Center as a Service (CCaaS) platforms underpin some modern outbound call centers, offering modular microservices architectures for scalability and customization. These platforms use orchestration tools like Kubernetes to manage containerized services, while service meshes like Istio ensure secure and efficient communication between components. CCaaS platforms integrate functionalities such as auto-dialing, analytics, CRM tools, and compliance monitoring into a unified framework. Advanced features, including digital twin simulations, allow managers to model and optimize operational strategies before implementation.

Supervisory tools may provide a comprehensive view of call center operations, including metrics like call connection rates, agent productivity, and campaign effectiveness. Real-time dashboards aggregate data from multiple systems and present actionable insights through business intelligence platforms. Supervisors use these insights to optimize strategies, allocate resources, and implement targeted training programs. AI-driven coaching tools further enhance agent performance by delivering personalized feedback and development resources.

Caller ID management in outbound call centers involves selecting displayed numbers based on various criteria to align with campaign objectives and maximize effectiveness. Algorithms are proposed to evaluate several factors to determine the optimal Caller ID for a given call. These factors may include, among other things, detailed analyses of call volume patterns, recipient demographics, and the performance of previous campaigns, all of which inform real-time decisions.

Certain algorithms dynamically select Caller IDs by analyzing a variety of factors to optimize call performance and maintain compliance. These factors include the recipient's location, the time of day, specific campaign requirements, and other contextual considerations discussed herein. One element is the carrier facilitating the call. The algorithms evaluate carrier performance metrics such as reliability, latency, geographic signal strength, historical call success rates, and other relevant indicators. This data is collected from ongoing network performance monitoring systems and dynamically adjusted based on the target region, time of day, or the carrier selected for the call.

The algorithms may prioritize carrier-specific metrics. For example, performance metrics associated with the carrier on which the call will be placed are weighted more heavily than those of other carriers. This approach helps align Caller ID selection with the strengths and limitations of the carrier being utilized. Additionally, regulatory compliance factors may be incorporated into the evaluation process. These may include verifying that the selected Caller ID adheres to regional regulations and is not associated with restricted usage.

The process of embedding a specific Caller ID number within the signaling protocol may involve customizing SIP headers in INVITE messages to specify the chosen number. This process involves a series of steps. SIP, the protocol used for initiating, maintaining, and terminating communication sessions in VoIP systems, requires the sending of an INVITE message to initiate a call. This message contains multiple headers, such as the From header, which specifies the Caller ID to be displayed, and optional headers like P-Asserted-Identity (PAI) and Remote-Party-ID (RPI), which may also carry Caller ID information for authentication or legacy purposes. The chosen Caller ID is dynamically selected by the call center's algorithms based on various criteria as contemplated herein. This number is retrieved from the system's number pool and passed to the SIP INVITE generation module. During construction of the INVITE message, the selected Caller ID is inserted into the appropriate SIP headers. For example, the From header might be populated with From: “Local Business” <sip:2125551234@domain.com>, embedding the number 2125551234. In some cases, additional headers like PAI may be used to ensure the Caller ID is authenticated and accepted by the carrier.

The SIP headers can be encrypted using Transport Layer Security (TLS), creating SIP-TLS. This ensures the Caller ID remains intact during transmission. Once the INVITE message is customized, it is transmitted to the carrier through a SIP trunk, where the carrier uses the embedded Caller ID information to display the number on the recipient's device.

The process may also include error handling and validation mechanisms. Carriers often validate Caller IDs against registered or pre-approved numbers, replacing unverified numbers with a default or blocking the call if validation fails. In such cases, the system may dynamically select an alternative number from the pool and regenerate the INVITE message. Routing enhancements, such as geographic tagging within the headers, may further improve call-answer rates by aligning the Caller ID with the recipient's location.

Dynamic management systems may further enhance this process by incorporating, for example, local presence software, which assigns numbers with area codes familiar to the recipient's region to improve answer rates. These systems may adapt dynamically to changing geographic calling patterns by analyzing region-specific historical call connection data and response trends.

Additionally, historical data about a number's reputation may be analyzed, including whether it has been identified for enhanced evaluation or for review by carriers. Some algorithms may assess the frequency and duration of such tags to determine whether a number should be rotated, replaced, or prioritized. Reputation management tools may monitor Caller ID performance by tracking detailed metrics such as connection rates, average call durations, and carrier evaluations. These tools can identify patterns of declining performance or highlight opportunities for optimizing Caller ID selections across multiple campaigns. Numbers identified for enhanced evaluation may be assessed in terms of how they impact call success rates. By analyzing trends in identified numbers across multiple carriers, these tools can recommend rotations or replacements to maintain optimal performance.

Technologies like STIR/SHAKEN may add cryptographic signatures to Caller IDs so that carriers can verify the displayed number. This process involves the generation and validation of digital certificates, which are embedded in SIP headers to authenticate the caller's identity. The systems may also generate detailed reports on Caller ID metrics, enabling ongoing refinement of selection strategies.

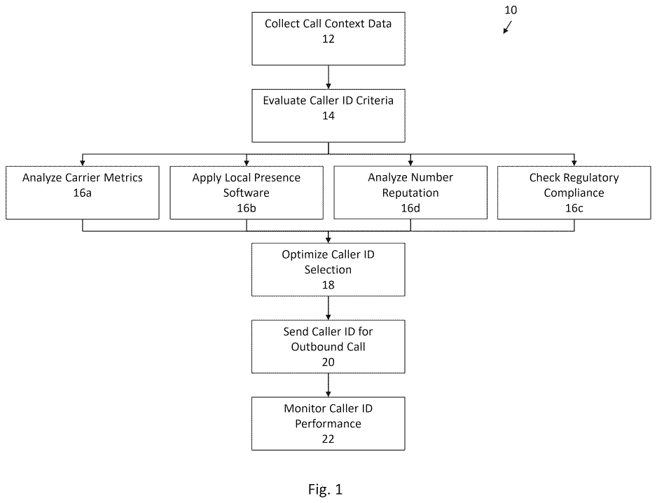

Referring to FIG. 1, a Caller ID selection algorithm 10 includes various operations. The flow begins with data collection and progresses through evaluation, optimization, execution, and monitoring, Specifically, the process begins with Collect Call Context Data 12, where a wide array of input data is gathered, including call volume patterns, recipient demographics, and the historical performance of previous campaigns. This foundational step may use real-time data ingestion pipelines, such as Apache Kafka or Amazon Kinesis, so that data remains up-to-date and reflective of current trends. These data streams can be processed using big data frameworks like Apache Spark to extract actionable insights that form the basis for predictive modeling and contextual analysis. For example, recipient segmentation models may use this data to predict optimal contact times or to identify high-value leads.

Next, Evaluate Caller ID Criteria 14 involves the application of algorithms to assess a range of contextual and operational factors. These may include recipient location, time-of-day preferences, and campaign-specific goals. This stage acts as a decision-making gateway that routes the process into specialized evaluation pathways. Gradient-boosted decision trees, neural networks, or ensemble learning techniques may be used to dynamically weigh these factors against campaign objectives. For instance, predictive models might calculate the probability of call connection success based on the recipient's historical engagement patterns.

Analyze Carrier Metrics 16a involves evaluating network-level performance indicators to determine the most effective carrier and phone numbers for call routing. These indicators include carrier reliability, latency, geographic signal strength, historical success rates for calls routed through specific carriers, and insights into the behavior of individual phone numbers within the network. Metrics such as the duration a phone number has been flagged for enhanced evaluation, the frequency of such flags, and the number of instances a number has been flagged are useful in making informed decisions.

Carrier analytics systems utilize real-time data from telecommunication provider APIs to benchmark performance across available carriers. For instance, a comparison might reveal that Carrier A has lower latency in rural regions compared to Carrier B, making Carrier A the preferred choice for those areas. Similarly, geographic signal strength analysis could highlight that Carrier C consistently delivers strong connectivity in a specific region, prompting the system to prioritize Carrier C for calls to that region.

The system may also monitor the behavior of phone numbers within the network. For example, a phone number flagged for enhanced evaluation by a carrier due to suspected high call volumes might be analyzed for how frequently and how long it remains flagged. Suppose a number was flagged for three consecutive days by a certain carrier during a previous campaign but has since remained unflagged for six months. In that case, the algorithm might consider it for use in a current campaign for calls on that carrier. In contrast, a number flagged intermittently over the past several months, especially during high-volume periods, might be deprioritized.

In another example, a phone number flagged by multiple carriers simultaneously for longer durations may indicate issues. Such a number might be immediately removed from active campaigns and scheduled for further review. Conversely, a number flagged briefly by a single carrier during a peak campaign period might still be utilized in specific scenarios, such as targeting regions where the flagging carrier is less prominent or in which other carriers are to be used.

The system can also analyze trends in flagging behavior to detect patterns. For instance, a number consistently flagged during calls made between 9 AM and 12 PM might indicate that its usage during peak business hours triggers enhanced evaluation by certain carriers. This insight could lead to temporal adjustments, such as using the number during off-peak hours or rotating it with other numbers in the pool.

Moreover, the frequency of flagging may be a factor. A phone number flagged only once in the past year may still be considered reliable, especially if it has successfully completed past calls without issue. On the other hand, a number flagged multiple times in the last month, even for short durations, might indicate an emerging issue that warrants proactive action, such as removing the number or replacing it with another from the pool.

By combining these insights into the behavior of phone numbers with traditional carrier performance metrics, the system can make dynamic and strategic decisions that optimize outbound call campaigns.

At Apply Local Presence Software 16b, algorithms may dynamically assign Caller IDs that match the recipient's geographic area code. This step may improve answer rates by leveraging geospatial data, behavioral patterns, and historical connection data to create a sense of familiarity for recipients. For instance, recipients in New York are more likely to answer calls originating from a local area code. Local presence algorithms may incorporate real-time geofencing data to refine the selections, adapting to shifting recipient locations and patterns.

The Check Regulatory Compliance phase 16c, when applicable, verifies that Caller ID configurations adhere to relevant legal and regulatory standards, including for example the Telephone Consumer Protection Act (TCPA) in the United States and the General Data Protection Regulation (GDPR) in the European Union. This phase incorporates compliance enforcement mechanisms directly into telephony APIs, allowing for real-time validation of Caller ID configurations before calls are initiated.

For instance, algorithms may cross-reference Caller ID numbers against regional Do Not Call (DNC) lists, automatically excluding numbers that are restricted from contacting individuals within specific areas. Additionally, the system can enforce restrictions on automated dialing for calls made to regions where such practices require prior consent or are prohibited altogether.

The system may also evaluate the regulatory feedback profile for each phone number in the pool. This evaluation includes analyzing whether a number has been identified by regulatory bodies or associated with reports submitted to oversight agencies, such as the Federal Trade Commission (FTC). For example, if a number has been linked to reports for enhanced regulatory evaluation, the system can deprioritize its usage or remove it from active campaigns. Conversely, numbers with no regulatory feedback may be prioritized for campaigns targeting regions with certain compliance requirements.

Analyze Number Reputation 16d involves an evaluation of the historical performance and overall reputation of available Caller IDs. This analysis aggregates a variety of metrics to assess how each number has been perceived and utilized over time. Metrics may include the frequency with which a phone number has been used for calls during specific time periods (e.g., one day, two days, one week), the persistence of non-positive evaluations or feedback, cross-carrier reputation scores, and other factors. These metrics provide insights into the effectiveness and reliability of each Caller ID within different contexts and campaigns.

To make these evaluations actionable, data from multiple sources is compiled into a ranking system. Machine learning models or other analytical tools can be used to process this data, identify patterns, and detect trends that could influence call success rates. For example, a machine learning model might uncover that a particular Caller ID has been flagged for enhanced evaluation across multiple carriers within a short timeframe. Such trends may indicate potential issues, prompting the system to deprioritize or replace that number in active campaigns.

In contrast, the analysis may highlight numbers with strong reputations and consistent performance across campaigns and carriers. These numbers can be prioritized for use. The system may also dynamically adjust rankings based on the changing reputation of numbers.

The Optimize Caller ID Selection phase 18 further consolidates inputs from all prior and other analyses, dynamically weighting each factor to select the most effective Caller ID for each call. Multi-objective optimization algorithms may be employed to balance competing priorities, such as cost efficiency, geographic relevance, and compliance requirements. For example, a campaign targeting a rural region may prioritize Caller IDs with high geographic relevance while balancing latency and compliance factors. Moreover, factors specific to a particular carrier on which a call is to be placed may be weighted more heavily as compared with factors specific to other carriers on which the call will not be placed.

At Send Caller ID for Outbound Call 20, the selected Caller ID is applied to the telephony system, where SIP headers are configured to display the chosen number. This stage ensures that the number presented to the recipient aligns with the algorithm's output and campaign strategy.

Finally, Monitor Caller ID Performance 22 completes the feedback loop by tracking post-call metrics such as connection rates, average call duration, customer engagement levels, and other parameters. Monitoring systems may leverage predictive analytics to identify emerging trends or potential performance declines. For instance, a sudden drop in connection rates for a specific Caller ID might trigger automated alerts and prompt a reassessment of its suitability. This permits continuous refinement of the system, adapting to evolving conditions and maintaining performance over time.

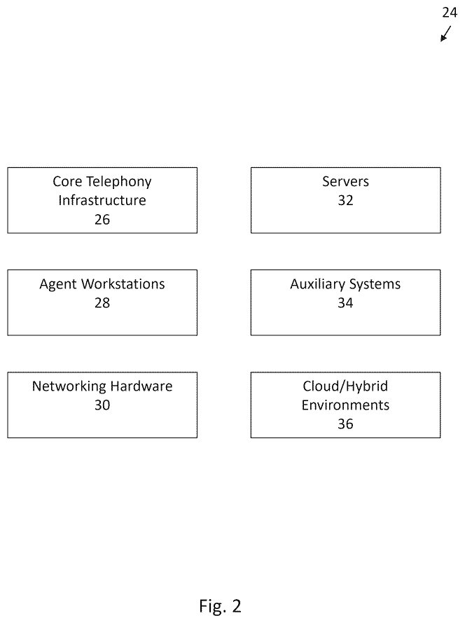

Referring to FIG. 2, an example architecture of an outbound call center 24 is built on an integrated system of technologies. At the center of this setup lies the Core Telephony Infrastructure 26, a collection of components that manage call routing and connectivity. The IP-PBX (Private Branch Exchange) serves as the telephony control hub, directing internal call distribution and connecting the call center 24 to external networks like VoIP and PSTN. This system facilitates functions such as voicemail, call queuing, conferencing, and internal communication. Complementing the IP-PBX are SIP Trunks, which act as virtual phone lines that transmit voice and signaling data over the Internet. These trunks offer a scalable solution for connecting to VoIP carriers. Additionally, Session Border Controllers (SBCs) are deployed to manage signaling and media packets for VoIP traffic. SBCs act as intermediaries between the IP-PBX and SIP Trunks, mitigating potential security threats while maintaining call traffic flow. For systems integrating both VoIP and traditional telephony, Gateways serve as components, converting VoIP signals into PSTN-compatible formats and vice versa.

The operation of the outbound call center 24 also relies on Agent Workstations 28, which serve as the primary interface for agents to interact with telephony systems and customers. Each workstation comprises Agent PCs or Terminals equipped with software such as CRM platforms and dialer interfaces. These systems enable agents to manage calls, retrieve customer information in real time, and maintain accurate records of interactions. In some setups, agents may use IP Phones as an alternative or complement to softphones, providing a hardware-based solution.

Supporting the telephony and workstation systems is a network infrastructure composed of Networking Hardware 30. Routers play a role in directing traffic between the call center's internal network and external networks, maintaining stable connections to VoIP carriers and the Internet. Within the internal network, Switches manage the flow of traffic between workstations, IP phones, and other connected devices. To protect the entire system from unauthorized access and external threats, Firewalls are deployed to filter incoming and outgoing traffic.

The backbone of the call center's operations is its Servers 32, each of which fulfills a specific function and comprises one or more processors. Among these, the Dialer Servers are for implementing algorithms that determine which number to display when placing an outbound call. These servers run auto-dialing software, such as predictive or power dialers, to automate the call initiation process. They execute Caller ID selection algorithms contemplated herein that evaluate various factors, including recipient location, time of day, campaign requirements, carrier performance metrics, and regulatory compliance. By dynamically analyzing this information in real time, the dialer servers select the optimal Caller ID from a predefined number pool and embed it into the SIP headers during call setup. Supporting this process are Database Servers, which store essential data such as number pools, historical performance metrics, reputation scores, and compliance guidelines. These servers provide the information required for dialer servers to make informed and effective decisions. Additionally, CRM Servers enhance the Caller ID selection process by offering customer-specific insights and segmentation rules, aligning the selection algorithms with campaign objectives. Complementing these systems are Call Recording Systems, which capture and store audio data for compliance, quality assurance, and training purposes.

The call center 24 may use a variety of Auxiliary Systems 34. Monitoring Dashboards provide supervisors with real-time visibility into metrics such as call connection rates, agent productivity, and campaign performance. These dashboards allow for adjustments to resources or strategies. Quality Assurance Stations enable supervisors to monitor agent interactions. To protect against power disruptions, Backup Power Supplies, including Uninterruptible Power Supply (UPS) units and generators, are implemented to maintain continuous operation of systems.

Some call centers leverage Cloud/Hybrid Environments 36. Cloud-Based Services, such as Contact Center as a Service (CCaaS), provide virtualized platforms for hosting telephony systems, data storage, and other functions. These services allow call centers to scale operations in response to changing demands. For remote agents, technologies like VPNs (Virtual Private Networks) and SD-WAN (Software-Defined Wide Area Networks) provide secure and reliable connections to the central system.

Outbound call centers achieve large-scale customer outreach through the integration of, for example, technologies, telephony systems, data analytics, and artificial intelligence. The proposed algorithms for Caller ID selection may evaluate a range of factors, such as carrier performance, local regulations, and customer preferences, to enhance connection rates. Models and optimization algorithms may dynamically adjust strategies to balance compliance, efficiency, and engagement. These systems enable outbound call centers to operate as versatile and reliable tools for businesses.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While example embodiments described above illustrate various implementations, they are not intended to encompass all possible configurations of the described technology. The language used in this specification serves as a description rather than a limitation. Modifications can be made without departing from the core principles and scope of the material described. Additionally, the features of different embodiments may be combined to create additional implementations.

What is claimed is:

1. A call management system comprising:
one or more processors of an outbound call center programmed to, for a call to be placed on a first carrier, select a phone number from a pool of phone numbers according to a number of instances one or more other carriers has tagged each of the phone numbers for enhanced evaluation, and embed the selected phone number into a header of a message that initiates the call.

2. The call management system of claim 1, wherein the one or more processors are further programmed to select the phone number according to a duration of time each of the phone numbers has been tagged for enhanced evaluation.

3. The call management system of claim 1, wherein the one or more processors are further programmed to select the phone number according to a frequency with which each of the phone numbers has been tagged for enhanced evaluation.

4. The call management system of claim 1, wherein the one or more processors are further programmed to select the phone number according to an area code associated with the call.

5. The call management system of claim 1, wherein the one or more processors are further programmed to select the phone number according to a number of instances each of the phone numbers has been used for calls during a period of time.

6. The call management system of claim 5, wherein the period of time is one day, two days, or one week.

7. The call management system of claim 1, wherein the one or more processors are further programmed to select the phone number according to metrics associated with the first carrier.

8. The call management system of claim 1, wherein the one or more processors are further programmed to select the phone number according to a regulatory feedback profile for each of the phone numbers.

9. A call management system comprising:
one or more processors of an outbound call center programmed to, for a call to be placed on one of a plurality of carriers, select a phone number from a pool of phone numbers according to carrier metrics for each of the carriers associated with each of the phone numbers such that the carrier metrics for the one of the carriers are weighted more heavily than the carrier metrics for the other of the carriers, and embed the selected phone number into a header of a message that initiates the call.

10. The call management system of claim 9, wherein the carrier metrics associated with each of the phone numbers include the number of instances the phone number has been tagged for enhanced evaluation.

11. The call management system of claim 9, wherein the carrier metrics associated with each of the phone numbers include a duration of time the phone number has been tagged for enhanced evaluation.

12. The call management system of claim 9, wherein the carrier metrics associated with each of the phone numbers include a frequency with which the phone number has been tagged for enhanced evaluation.

13. The call management system of claim 9, wherein the one or more processors are further programmed to select the phone number according to non-carrier metrics associated with each of the phone numbers.

14. The call management system of claim 13, wherein the non-carrier metrics include an area codes associated with the call.

15. The call management system of claim 13, wherein the non-carrier metrics include a number of instances each of the phone numbers has been used for calls during a period of time.

16. The call management system of claim 13, wherein the non-carrier metrics include a regulatory feedback profile for each of the phone numbers.
